(19) United States
(12) Patent Application Publication
(10) Pub. No.: US 2010/0213152 A1
(43) Pub. Date: Aug. 26, 2010

(54) METHOD AND DEVICE FOR ATTACHING AND REMOVING AN ADDITIONAL DEVICE TO AND FROM THE MAIN JIB OF A MOBILE CRANE

(75) Inventors: Michael Martin, Illingen (DE); Roland Kuhn, St. Ingbert (DE); Udo Biwer, Nonnweiler (DE)

Correspondence Address: CANTOR COLBURN, LLP, 20 Church Street, 22nd Floor, Hartford, CT, 06103, US

(73) Assignee: TEREX DEMAG GMBH A GERMAN CORPORATION, Zweibrucken (DE)

(21) Appl. No.: 12/712,447

(22) Filed: Feb. 25, 2010

(30) Foreign Application Priority Data
Feb. 26, 2009 (DE) DE102009010452.6

(51) Int. Cl. B66C 23/70; B23P 11/00

(52) U.S. Cl. 212/177; 29/525.11

(57) ABSTRACT

The invention relates to a method and to a device for attaching and removing an additional device comprising individual elements to and from the main jib of a mobile crane using no auxiliary crane. In the method according to the invention, a partial piece (2.1) of the additional device (2) composed of partial pieces is raised into an inclined position while being rotated about an upper pivot point (C), and the head (1.2) of the main jib (1.1) is bolted to the lower end of the inclined end of the partial piece (2.1) of the additional device (2) facing the mobile crane so as to be able to rotate. Using a hoist cable (7), all partial pieces (2.1 to 2.7) are raised in alignment with respect to each other and the main jib (1.1), and are bolted to each other in this position and to the main jib. The invention furthermore relates to a displacement device for carrying out the method according to the invention.

### CROSS REFERENCE TO RELATED APPLICATION

This application claims the benefit of German patent application No. 10 2009 010 452.6 filed Feb. 26, 2009, the contents of which are incorporated herein by reference thereto.

### FIELD OF THE INVENTION

The invention relates to the attachment and removal of an additional device to and from the main jib of a mobile crane, which is to be done without the use of an auxiliary crane.

### BACKGROUND

It is known how in mobile cranes, particularly telescoping cranes, to attach an additional device to the head of the main jib of the base crane. Such a device is used to achieve a jib length that extends even further beyond the maximum jib length of the telescoping crane. The devices are generally designed as modular systems and can be combined as a function of required length or lifting capacity.

Ideally, the individual main elements of the device have a lattice/pipe design in transportable dimensions. The device elements are joined with pins at corresponding points to form a single unit.

In most cases, the additional device will not be carried together with the base crane and must be transported separately. Devices provided specially for this purpose, however, may also be carried together with the base crane, weight and space conditions permitting. The attachment to the main jib head can occur piece by piece, or as a preassembled unit in a known manner with an additional auxiliary crane.

The use of an auxiliary crane entails additional costs because it requires additional personnel to move it close to the setup location. In addition, it is difficult to guide the freely floating and raised additional device with pinpoint precision to the fastening points provided at the jib head of the mobile crane, while keeping the risk of injury for the installers in mind. This means a relatively high expenditure of time for installation.

It is therefore an object of the invention to simplify the attachment of the additional device and make it safer, in particular, to carry it out without the use of an additional auxiliary crane.

### SUMMARY

In an exemplary embodiment, a method for attaching and removing a preassembled additional device comprising individual elements, to and from the main jib of a mobile crane comprises placing the preassembled additional device, which may have a lattice/pipe design in transportable dimensions, on the ground in alignment with the main jib of the mobile crane. A partial piece, at the end of the additional device facing the mobile crane, is raised into an inclined position while being rotated about an upper pivot point and is held in this position. A head of the preassembled additional device is bolted to the lower end of the inclined end of the partial piece of the additional device facing the mobile crane so as to rotate and, the additional device is pulled into a horizontal position using a hoist cable fastened on the end of a second partial piece raised in an inclined position, at the end of the preassembled additional device facing away from the mobile crane, and guided over a roller, such that the second partial piece of the preassembled additional device, the remaining parts of the preassembled additional device, and the main jib of the mobile crane are aligned behind one another in orientation. The components are connected to each other and to the head of the main jib by bolting them thereto.

The above features and advantages, and other features and advantages of the present invention are readily apparent from the following detailed description when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIGS. 1 to 5 illustrate the attachment, according to the invention, of the additional device, with angling of the two partial pieces of the additional device;

FIG. 6 illustrates the attached additional device without prior angling of the partial piece of the additional device facing away from the mobile crane;

FIG. 7 illustrates the details of the partial piece of the additional device marked with “FIG. 7” in FIG. 3 in an inclined position.

FIG. 8 illustrates the details of the partial piece of the additional device marked with “FIG. 8” in FIG. 3 in an inclined position;

FIG. 9 illustrates the design of the end piece of the additional device with the wheel;

FIG. 10 illustrates the direction of displacement in a front view; and

FIG. 11 illustrates the direction of displacement in a side view.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

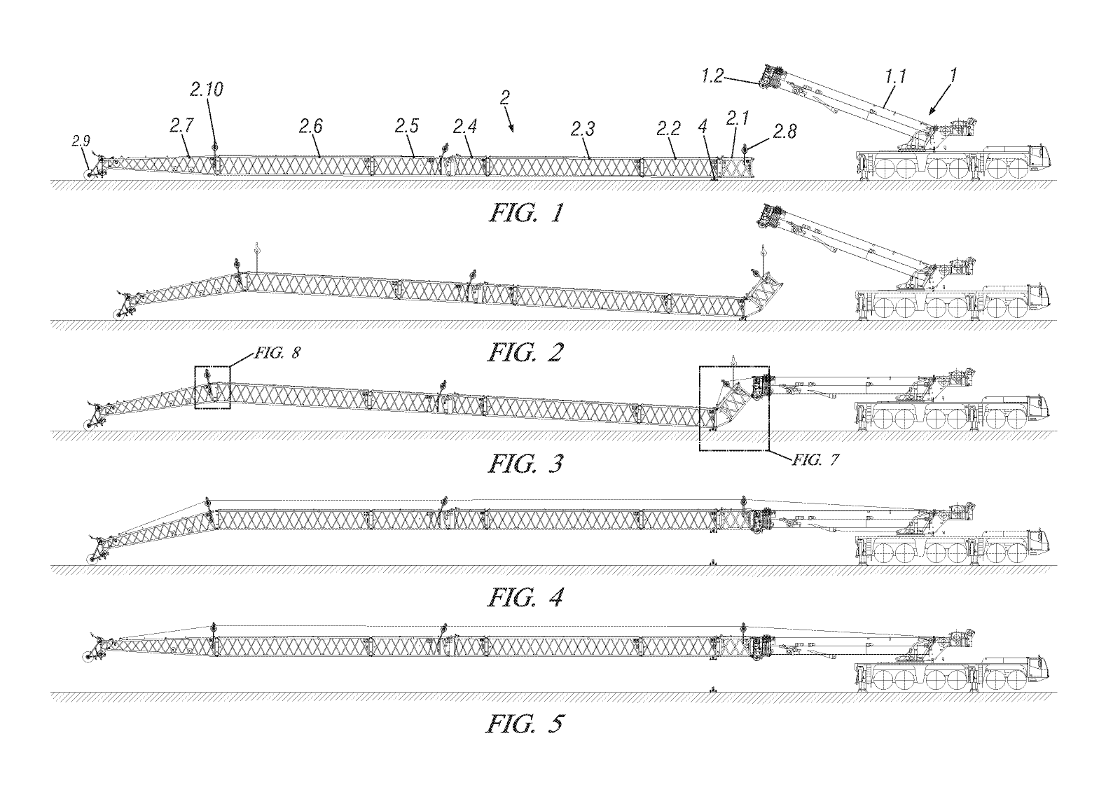

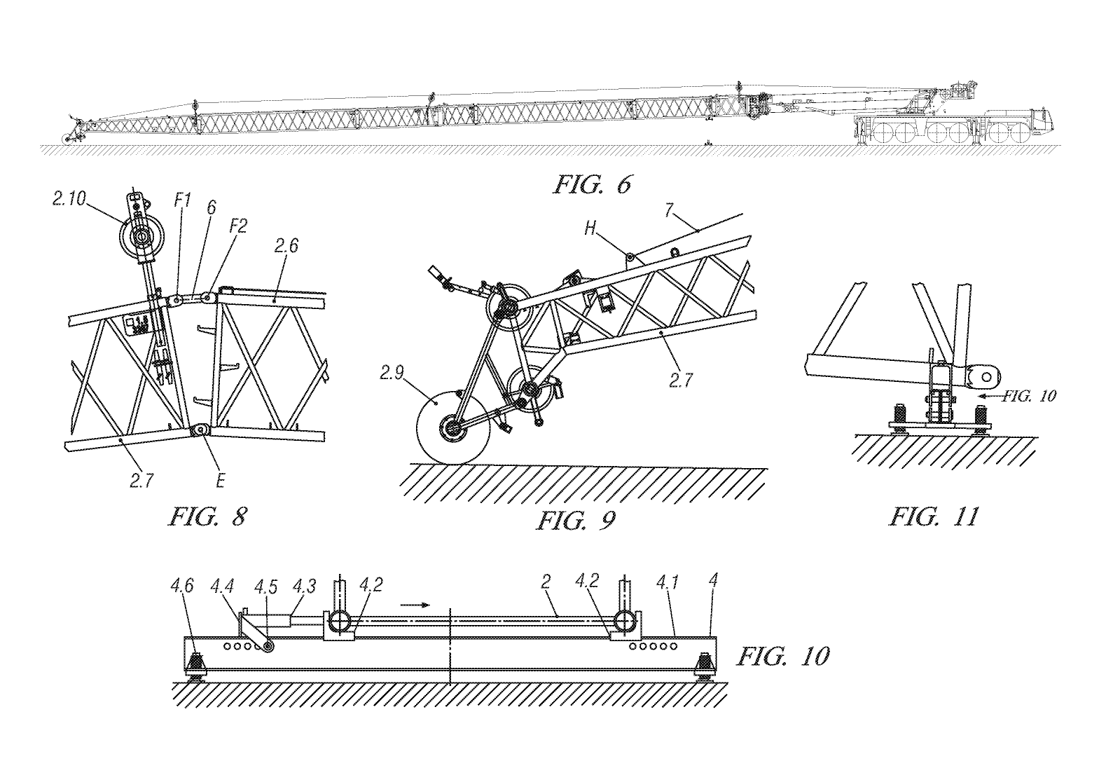

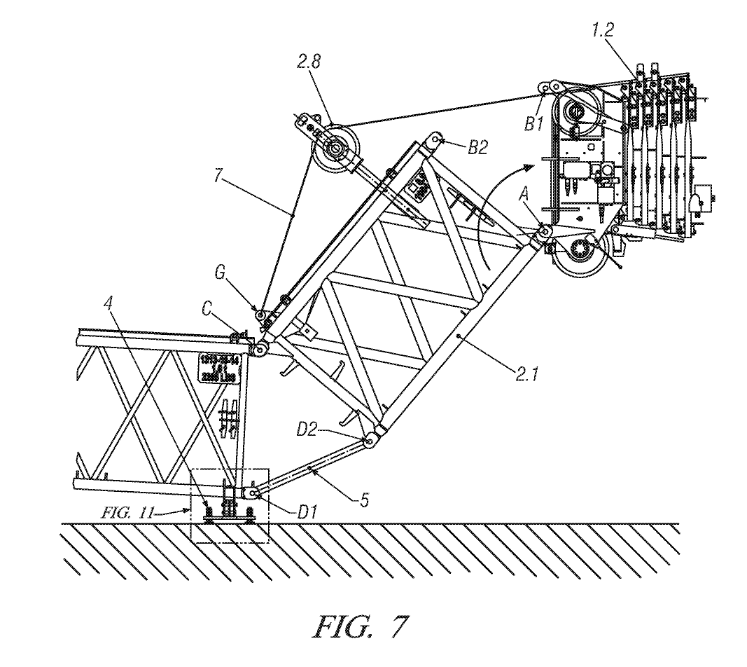

Using the mobile crane 1, the additional device 2 may be assembled from several individual elements 2.1 to 2.7 in the desired configuration and placed on the ground in axial alignment with the main jib 1.1 of the mobile crane 1. The end of the additional device 2 facing the mobile crane 1, as is shown in FIG. 1, is placed on the displacement device 4, (FIGS. 7, 10 and 11), with the individual element 2.2 and oriented with respect to the main jib by displacement.

A first partial piece 2.1 of the additional device, also referred to as the head connection, is then raised with the crane 1, (FIGS. 2 and 7), and thereby rotated upward about point C (FIG. 7) and a spacer rod 5 is introduced between points D1 and D2 for fixing the inclined position of the partial piece 2.1. Thereafter, a second partial piece 2.7, also referred to as the tip or distal end of the additional device facing away from the mobile crane is rotated downward about point E (FIG. 8) into an inclined position by raising the additional device 2, and a spacer rod 6 (FIG. 8) is inserted between points F1 and F2 for fixing the inclined position. The angled position of the tip of the additional device 2 is required for establishing the horizontal alignment with the main jib 1.1 of the mobile crane 1 to allow subsequent bolting at point B (FIG. 7).

The main jib head 1.2 is guided close to the inclined first partial piece 2.1 and bolted to it at point A. The orientation of the parts with respect to each other and the alignment of the bores in point A are made possible by moving the main jib 1.1 and by displacing the additional device 2 using the displacement device 4 (FIGS. 10 and 11). After the bolting at point A, the spacer rod 5 can be removed.

A hoist cable 7 of the crane is guided over the roller 2.8 (FIGS. 3 and 7) and attached at point G. By retracting the hoist cable 7, the first partial piece 2.1, that is hinged at points A and C, rotates so far upward until point B1, at the head of the main jib, can be bolted to point B2 of the partial piece 2.1. In the raised state of the device, point D1 at the device element 2.2 can also be connected to point D2 at the partial piece 2.1. The result is the state illustrated in FIG. 4.

In order to enable removal of the spacer rod 6, the main jib 1.1 with the additional device 2 located in front of it is rocked or raised until the wheel 2.9 is just about to lift off the ground. The bolted connection at points F1 and F2 is thereby relieved and can be detached, and the bolt connection of the spacer rod 6 can be released, and the rod removed. The hoist cable 7 is now fastened at point H by way of the roller 2.10 (FIGS. 4 and 9). By retracting the hoist cable, the second partial piece 2.7 of the additional device 2 is rotated about point E (FIG. 8), thereby lifting off the ground until points F1 and F2 can be bolted together. After bolting, the hoist cable is detached from point H and attachment of the additional device 2 to the main jib 1.1 of the mobile crane 1. The removal of the additional device is carried out in reverse order.

In an exemplary embodiment, the inclined positions of the first and second partial pieces 2.1 and 2.7 of the additional device 2 could also be brought about by a cylinder or a similar apparatus instead of raising the hoist cable.

In another exemplary embodiment, the raising of the additional device and the fixed inclined position of the second partial piece 2.7 can be eliminated, if the main jib 1.1 can be angled so far down (subsurface position see FIG. 6) or if the entire crane can be inclined such that the tip of the device 2 in the finished, attached state of the device had contact with the ground via the wheel 2.9.

An exemplary embodiment of the displacement device 4 is illustrated in FIGS. 10 and 11. The additional device 2 is located on the two sliding pieces 4.2 of the displacement device 4 which can slide on a main jib 4.1. Using the piston rod of the lifting cylinder 4.3, the sliding pieces 4.2 with the additional device 2 placed thereon are pushed over the sliding plane of the main jib 4.1 into the desired position. The cylinder bearing 4.4 is fastened to the main jib 4.1, using a locking pin 4.5, to the right or left of the additional device 2, depending on the required direction of displacement. An adjustment in the vertical direction can be carried out using the height-adjustable feet 4.6.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

1. A method for attaching and removing an additional device to and from the main jib of a mobile crane using no auxiliary crane,
comprising:
placing the additional device (2) on the ground in alignment with the main jib (1.1) of the mobile crane (1);
raising a partial piece (2.1), at the end of the additional device (2) facing the mobile crane, into an inclined position while being rotated about an upper pivot point;
holding the raised partial piece in the inclined position;
bolting the head (1.2) of the main jib (1.1) to the lower end of the inclined end of the partial piece (2.1) of the additional device (2) facing the mobile crane so that the raised partial piece is rotatable relative to the additional device;
pulling the additional device (2) into a horizontal position using a hoist cable (6) fastened to an end of the partial piece (2.1) facing away from the mobile crane (1) and guided over a roller (2.8), such that the partial piece (2.1) of the additional device (2 and the main jib (1.1) of the mobile crane are aligned behind one another in orientation; and
connecting the preassembled additional device to the head (1.2) of the main jib (1.1).

2. The method according to claim 1, wherein
the additional device (2) has a multi-piece lattice/pipe design, of transportable dimensions.

3. The method according to claim 1,
further comprising;
raising the additional device (2), at the end facing away from the mobile crane (1) such that a second partial piece (2.7) of the additional device (2), that is rotatable about a lower pivot point (E), assumes an inclined position and the second partial piece (2.7) assumes an inclined position with an end of the partial piece (2.7) maintaining contact with the ground prior to raising the partial piece (2.1) of the additional device (2);
raising the partial piece (2.1) of the additional device (2) facing the mobile crane (1);
raising the inclined second partial piece (2.7) of the additional device (2), located at the end facing away from the mobile crane, by pulling a lifting cable that is fastened to a head point (H) of the second partial piece (2.7) of the additional device (2) such that the partial pieces (2.1, 2.7) of the additional device (2), the additional device, and the main jib (1.1) of the mobile crane (1) are aligned behind one another in orientation, and
connecting the components (2, 2.1 and 2.7) to each other and to the head (1.2) of the main jib (1.1).

4. A method according to claim 1, wherein
the temporary inclined position of the partial pieces (2.1) of the additional device (2) is secured by a spacer rod (5).

5. The method according to claim 1, further comprising
placing the end of the additional device (2) facing the mobile crane (1) onto a displacement device (4), configured to transversely displace the longitudinal axis of the additional device (2), into an aligned orientation of the additional device (2) with respect to the jib (1.1) of the mobile crane (1).

6. A method according to claim 3, wherein
the raising and inclining of the first and second partial pieces (2.1, 2.7) of the additional device (2) is carried out using a hoist cable of the mobile crane (1).

7. A method according to claim 3, wherein
the raising and inclining of the first and second partial pieces (2.1, 2.7) of the additional device (2) is carried out using a lifting cylinder.

8. An additional device for attachment to the main jib of a mobile crane, comprising:
a partial piece (2.1), disposed at an end of the additional device (2) facing the mobile crane (1), having a hinge (C) operable to angle the partial piece (2.1) relative to the additional device (2);
a roller (2.8) for guiding a hoist cable is fastened to the partial piece (2.1);
fastening elements (A, B2, C, D1, D2) located on the partial piece (2.1), for fastening of a spacer rod (5) to maintain the angled state of the partial piece (2.1) of the additional device (2), and for fastening the partial piece (2.1) to an adjoining part (2.2) of the additional device (2) and to a head (1.2) of the main jib (1.1) of the mobile crane (1).

9. The additional device according to claim 8,
further comprising:
a second partial piece (2.7) disposed at the end of the additional device (2) facing away from the mobile crane (1) having a hinge (C) disposed at a first end of the second partial piece and operable to angle the second partial piece (2.7) relative to the additional device (2);
a roller (2.10) for guiding a lifting cable fastened to the second partial piece (2.7) and having fastening elements (F1, F2) configured to fasten a spacer rod (6) to maintain the second partial piece (2.7) in an angled state relative to the additional device (2), and configured to fasten the second partial piece (2.7) to an adjoining part (2.6) of the additional device (2) such that an aligned state of the parts of the additional device (2) is facilitated; and
a wheel (2.9) disposed at a second, opposite end of the second partial piece (2.7) of the additional device.

10. A displacement device for displacing an additional device transversely to its longitudinal axis, comprising:
a principal beam (4.1) defining a sliding plane;
threaded feet supporting the principal beam (4.1) and configured to adjust the vertical height of the beam;
sliding pieces (4.2) carrying the additional device (2) disposed on the beam and configured to displace the additional device transversely;
a cylinder carrier (4.4) fastened to the principal beam (4.1) and having a lifting cylinder (4.3) including a lifting rod configured to displace the sliding pieces (4.2) on a sliding plane of the principal beam (4.1).
